(19) United States
(12) Patent Application Publication
(10) Pub. No.: US 2011/0180282 A1
(43) Pub. Date: Jul. 28, 2011

(54) WRAP AROUND DOZER BLADE HITCH

(75) Inventors: Cory Allan Reavie, Regina (CA); Tyler James Sakundiak, Regina Beach (CA)

(73) Assignee: Degelman Industries LTD., Regina (CA)

(21) Appl. No.: 12/694,006

(22) Filed: Jan. 26, 2010

(51) Int. Cl. A01B 59/00; E02F 3/627; B62D 49/04

(52) U.S. Cl. 172/273; 172/817

(57) ABSTRACT

A frame attachment and link between a materials moving implement, for example a dozer blade, and a vehicle for instance a conventional farm tractor which enables the operator to laterally adjust and raise and lower the dozer blade a substantial distance and yet is relatively easily connected and disconnected with the vehicle. The attachment described herein is a U-shaped frame having a front end including a central pivot attachment point at the base of the U, and several hydraulic attachment points which permit the lateral movement of the dozer blade relative to the vehicle. The U-shaped frame defines an opening which is large enough to accommodate the front frame and body of the of the tractor or vehicle so that the U-shaped frame when in a raised position, encompasses within the opening the front frame and body of the vehicle so that there is sufficient vertical articulation of the dozer blade without interference from the vehicle body.

### FIELD OF THE INVENTION

The present invention relates to a vehicle hitch attachment assembly utilized generally on tractors such as wheeled and tracked farming and agricultural tractors. In particular, the present invention relates to a highly articulated hitch attachment assembly for securing a dozer blade or similar materials moving implement to a tractor that surrounds and encompasses the front end of the tractor.

### BACKGROUND OF THE INVENTION

Various styles of hitches to support materials moving implements, e.g. buckets, blades, shovels, forks, etc., on vehicles are used across the agricultural and industrial equipment industry. Vehicles may be of the loader or tractor type and in particular work vehicles such as wheeled and tracked tractors for attachment of implements to the front and back of the work vehicle for moving desired materials, e.g. earth, snow, agricultural products and debris just to name a few. Very often on a farm tractor for instance, it is desired to mount a dozer blade for material handling and moving purposes. Usually, such implements need to be mounted to the front of the vehicle. While there are a number of standard hitches which allow relatively static attachment of such dozer blades to the front of a tractor, there are few if any which permit both substantial lateral and vertical, as well as tilting articulation of the blade relative to the tractor and the ground. In the known types of relatively static implement attachments, a vehicle operator must maneuver the vehicle in a manner which is awkward and less efficient than if the dozer blade is permitted to have independent vertical, tilting and lateral movement capabilities.

There are for example known in the industry three point hitches which can be front or rear mounted to a three point hitch implement such as the dozer blade secured to the vehicle. One of the problems with standard three point hitches is that the hitch and link for the implement such as a dozer blade significantly spaces the implement from the front of the vehicle. Because the attachment point of the link extends forward of the front of the vehicle the upper pitch link substantially increases the distance separating the implement from the forward most point of the work vehicle. As a result, the mass balance of the vehicle and implement can be significantly changed and the operator is often separated by a great distance from the object they are trying to move, or from an intersection where visibility is critical. For these reasons, many regulations have set limits for the maximum distance that the operator can be spaced from the forward most point of the work vehicle. For example, some European regulations limit the distance separating the forward most point to the vehicle from the steering wheel to 3.5 m.

Because in such three point hitches the implement is carried well forward of the work vehicle's center of mass, and forward of the front axle, the mass of the implement carried by a hitch can transfer larger undesirable loads to the work vehicle. The larger loads reduce vehicle stability and create greater loads on the drive trains of the vehicles during transport and field operations. Furthermore, in the known three point hitches the ability of the vehicles to raise and lower the dozer blade implement to a sufficient height relative to the ground in certain circumstances is either non-existent, or compromised by the mass and dimensions of the vehicle body which can interfere with any mechanism or attachment which might raise or lower the implement relative to the ground and the front of the vehicle.

Thus, there is a continuing need for a front mounted hitch and attachment system to permit the desired articulation for an implement supported on a vehicle wherein the mass of the implement is carried as close to the vehicle as possible to reduce stresses and safety issues with respect to operation of work vehicle. The below described attachment system provides a pivot point as close to the front of the vehicle and front axle of the vehicle as possible, and also includes a frame which is able to accommodate the front of a work vehicle within it so as to provide a sufficient raise and lower height adjustment and articulation for the dozer blade as well as side-to-side adjustment, i.e. lateral movement of the dozer blade.

### SUMMARY OF THE INVENTION

The present invention provides for a frame attachment and link between a materials moving implement, for example a dozer blade, and a vehicle for instance a conventional farm tractor which enables the operator to laterally adjust and raise and lower the dozer blade a substantial distance and yet is relatively easily connected and disconnected from the vehicle. The attachment described herein is a U-shaped frame having a front end including a central pivot attachment point at the base of the U, and several hydraulic attachment points which permit the lateral movement of the dozer blade relative to the vehicle. The U-shaped frame is further provided with a rear pivot point extending between the free ends of the U, which is connected to a frame link and spaced from the front of the vehicle and as close to the front axle of the vehicle as possible. The U-shaped frame defines an opening which is large enough to accommodate the front frame and body of a tractor or vehicle so that the U-shaped frame when in a raised position, encompasses within the opening the front frame and body of the vehicle so that there is sufficient vertical articulation of the dozer blade without interference from the vehicle body.

There are other critical factors to consider with such dozer blade implements as well, one of the most important being that the side support arms of the hitch for the dozer blade being in a lowermost operative position below the height of the front axle for the most effective pushing and cutting operations. Understanding that the lower cutting edge of a dozer blade absorbs and transmits the highest forces through the hitch to the vehicle, it is important to deliver those forces in the most linear manner as possible to the vehicle. In this operative position the side support arms must generally be aligned substantially parallel with the ground and at a lower height relative to the ground than the height of the front axle. This is important because it helps keep the center of gravity of the attachment and vehicle low to the ground and deliver the forces in the most linear manner, i.e. a very low angle, from the cutting edge of the dozer blade.

For example opposite to most dozer blades, a front loader generally has side support arms that are well above the height of the front axle no matter what position the bucket is in and the forces are delivered at a very high angle to the vehicle. With the dozer blade having the side support arms positioned substantially entirely below the height of the front axle not only is the center of gravity of the hitch and blade maintained lower relative to the frame and center of gravity of the vehicle itself, but this arrangement also improves the steering of the vehicle.

Also improving the steering and handling of the vehicle is the fact that the disclosed U-shaped frame member maintains the blade itself very close to the front of the vehicle while still being able to raise the U-shaped frame and the blade to encompass the body of the vehicle. Thus, even in a raised position the blade is very close to the front of the vehicle and good steering and handling of the vehicle can be maintained.

The U-shaped frame member is attached to the body via a frame link which has a quick connect and disconnect frame attachment member for easily mounting and dismounting the U-shaped frame and frame link from the vehicle. The frame link also includes vertical hydraulic support attachment points which enables the vertical articulation of the U-shaped frame and blade implement.

The present invention is directed to a materials moving implement attachment apparatus for a vehicle including a U-shaped frame having a first side member and a second side member connected at respective first ends by a base member extending therebetween, a blade support is provided on the base member for attachment of a materials moving blade, a rear pivot hinge connected between a respective second end of each of the first and second side member and the first and second side members define an opening therebetween having a larger dimension than a front body section of the vehicle permitting the U-shaped frame to be rotated about the rear pivot hinge and allowing at least a portion of the front body section of the vehicle to pass entirely through the space between the first and second side members.

The present invention is also directed to a materials moving implement hitch for a vehicle including a U-shaped frame having a pair of generally parallel side members, each side member having a vertical actuator attachment and a horizontal actuator attachment, a base member connecting forward ends of the side members, a blade support affixed to the base member for attachment of a materials moving blade, a rear pivot brace affixed to the rearward end of each side member, a frame link for vertically, pivotally affixing the U-shaped frame to a vehicle, the frame link having a pair of oppositely disposed mounting plates, each mounting plate adapted to secure to a vehicle and rotatably engage with one of the pivot braces of the U-shaped frame, and wherein the pair of generally parallel side members are spaced apart a distance exceeding a width of a front body portion of the vehicle and the U-shaped frame is movable between a first position substantially parallel aligned with a ground surface below the front body portion of the vehicle and a second position wherein U-shaped frame rotates about the frame link to encompasses the front body portion of the vehicle between the generally parallel side members.

The present invention is also directed a method for manufacturing a materials moving implement attachment apparatus for a vehicle including forming a U-shaped frame having a first side member and a second side member connected at respective first ends by a base member extending therebetween providing a blade support on the base member for attachment of a materials moving blade, connecting a rear pivot hinge between a respective second end of each of the first and second side members, and defining an opening between the first and second side members having a larger dimension than a front body section of the vehicle permitting the U-shaped frame to be rotated about the rear pivot hinge and allowing at least a portion of the front body section of the vehicle to pass entirely through the space between the first and second side members.

These and other features, advantages and improvements according to this invention will be better understood by reference to the following detailed description and accompanying drawings.

### BRIEF DESCRIPTION OF THE DRAWINGS

Several embodiments of the present invention will now be described by way of example only, with reference to the accompanying drawings in which:

FIG. 1 is a side elevation-view of the front hitch attachment mechanism in a raised position in accordance with the present invention;

FIG. 2 is a side elevation-view of the front hitch attachment mechanism in a lowered position;

FIG. 3 is a perspective view of a tractor front hitch attachment mechanism in a raised elevated position;

FIG. 4 is a perspective view of the U-shaped frame member of the front hitch attachment mechanism;

FIG. 5 is a top plan view of the U-shaped frame member;

FIG. 6 is a perspective right-side view of the U-shaped frame member and frame link of the attachment mechanism;

FIG. 7 is a side elevation view of the hitch attachment, hydraulics and blade implement;

FIG. 8 is a perspective view of the hitch attachment, hydraulics and blade implement;

FIG. 9 is a top plan view of the hitch attachment, hydraulics and blade implement;

FIG. 10 is a top plane view of the U-shaped frame member and frame link supported on a vehicle and the vehicle frame and body within the open area defined by the U-shaped frame;

FIG. 11 is a side elevation and cutaway-view of the front hitch attachment mechanism in a raised position with the quick-release assembly of the hitch and vehicle frame shown with a materials moving blade attached in accordance with the present invention;

FIG. 12 is a cross-section view of the quick-release assembly in a hitch unsecured arrangement;

FIG. 13 is a perspective view of the quick-release assembly in the unsecured arrangement;

FIG. 14 is a cross-section view of the quick-release assembly in a hitch secured arrangement;

FIG. 15 is a perspective view of the quick-release assembly in the hitch secured arrangement;

FIG. 16 is a perspective view of another embodiment of a quick-release assembly;

FIG. 17 is a side elevation view of this further embodiment of a quick-release assembly in an unsecured position; and

FIG. 18 is a side elevation view of this further embodiment of a quick-release assembly in a secured position.

### DETAILED DESCRIPTION OF THE INVENTION

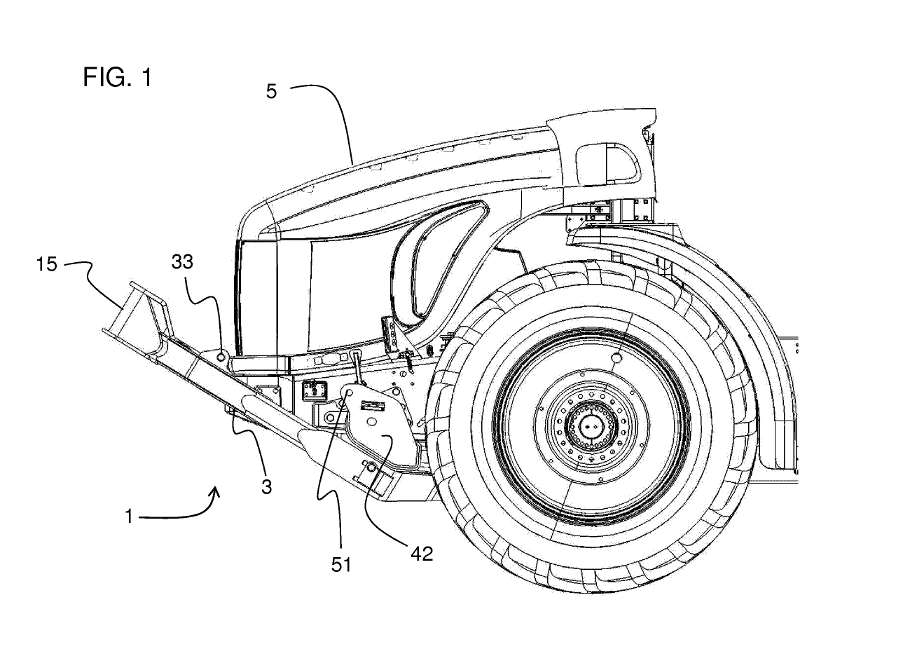

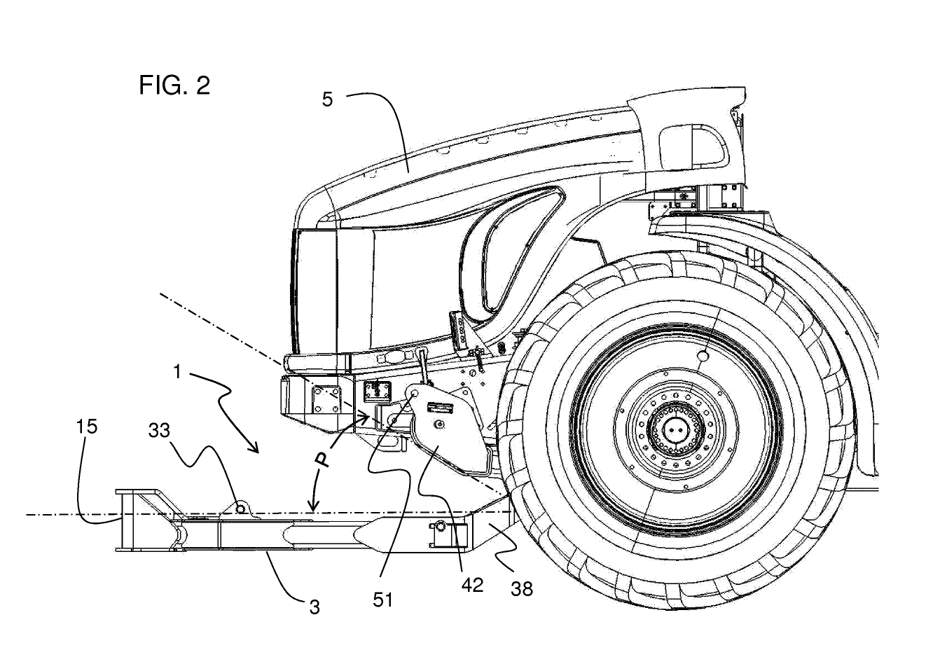

FIGS. 1 and 2 are side elevation views of a body of a vehicle 5 and a hitch attachment 1 showing a U-shaped frame 3 in a raised and lowered position, respectively. The U-shaped frame 3 is shown here without any of the requisite hydraulics which motivate the U-shaped frame up and down. Nor is a blade or materials moving implement shown supported on the frame member here for purposes of clarity of the following initial description. It is to be appreciated that in the lowered position as shown in FIG. 2 a blade implement would normally be resting on the ground so that materials can be efficiently moved. There is an angle P defined between the U-shaped frame 3 and a frame link bracket 42 such that the U-shaped frame 3 can raise and lower the blade implement substantially vertically relative to the ground around the front of the vehicle between the raised and lowered positions of the attachment. The angle P is generally established between 0-90 degrees or alternatively between about 0-60 degrees and with a preferred angle P being between about 0-45 degrees. It is to be appreciated as shown in FIG. 2 that the angle P includes at least a portion of the tractor body 5 and/or frame F so that the body 5 and frame are encompassed within the U-shaped frame in its uppermost, raised positions. Such raising and lowering of the U-shaped frame 3 is caused by the extension of a hydraulic piston extending between an upper rear hydraulic attachment point 51 on the frame link bracket 42 and a lower hydraulic attachment point 33 on the U-shaped frame 3.

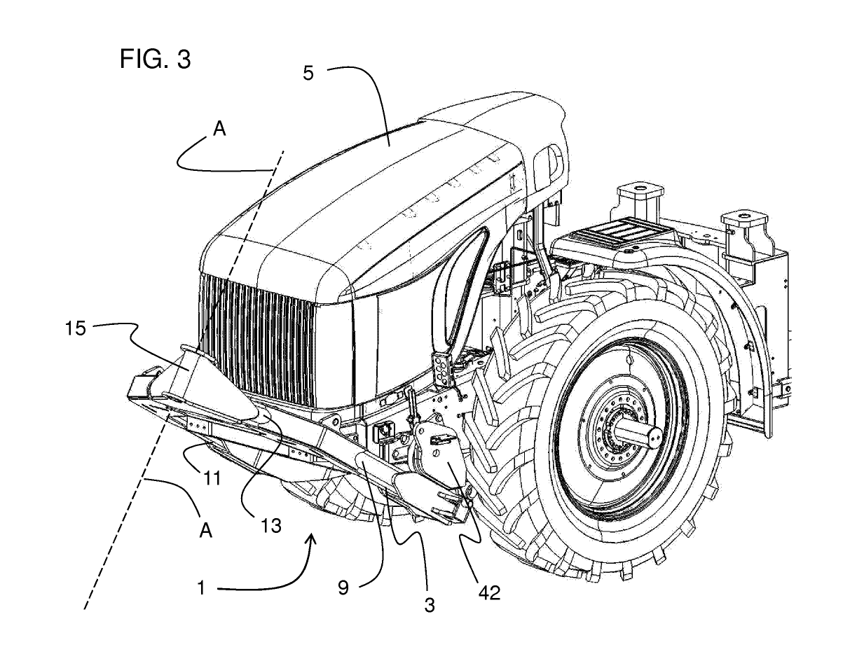

FIG. 3 is a perspective view of the hitch attachment assembly 1 including the U-shaped frame 3 in the raised position in conjunction with the front body portion 5 of an agricultural tractor. From a structural standpoint, the U-shaped frame 3 is generally defined by a left side member 9 and a right side member 11 connected by a base member 13 supporting a central pivot 15 at the front of the U-shaped frame 3. It is to be appreciated that the central pivot 15 on the front of the U-shaped frame 3 is the main direct connection and support of the blade or materials moving implement by the U-shaped frame 3. The central pivot 15 is defined about a main axis A through which a connecting portion of the blade implement is enabled to rotate so as to provide lateral movement of the implement about the main axis A relative to the U-shaped frame 3 and the vehicle 5. The lateral movement is caused by the extension of a hydraulic piston extending to the blade implement from a rear lateral hydraulic attachment point 21 as will be further described below.

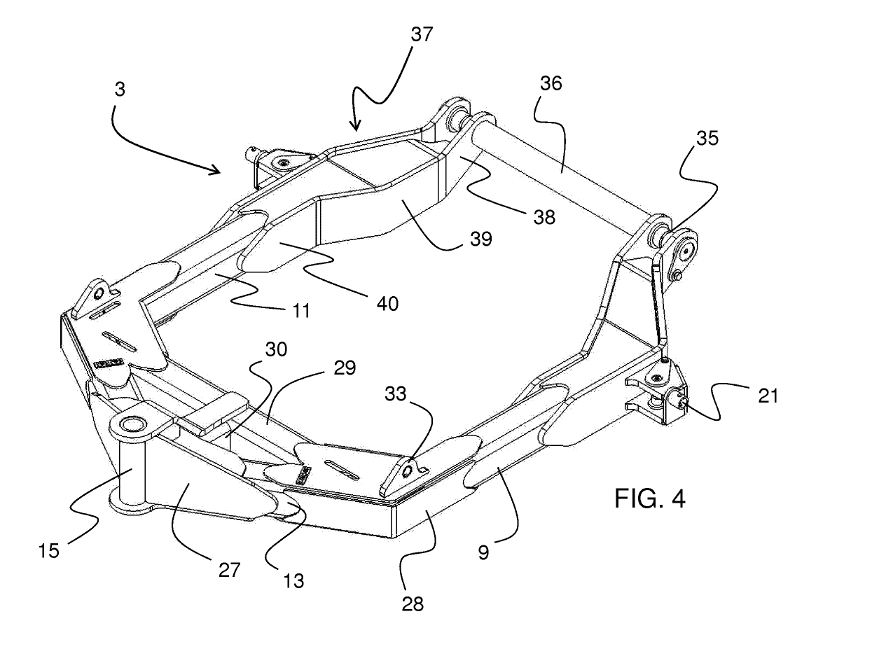

Turning to FIG. 4, the U-shaped frame 3 is comprised of the left side member 9 and the right side member 11 joined by a base member 13 extending between the respective ends of the left and right side members 9, 11 to form the bottom portion of the U-shape. The base member 13 is shown having an apex defining the central pivot 15 which rotatably supports a matching engagement part of a blade implement. The central pivot 15 and the apex of the base member 13 are reinforced on a front side with a central pivot gusset 27 supporting and securing the central pivot 15 to the base member 13 on either or both sides of the apex. Additionally, a reinforcement support member 29 is provided on the back side of the base member 13 which extends as a linear chord between the side members so that a strengthening triangle is formed with the base member 13 of the U-shaped frame 3 to directly support the connection of the central pivot 15 with the materials moving implement. A further direct support bar 30 may also be placed between a central portion of the reinforcement support member 29 and the apex of the base member 13 to further support the central pivot 15. It is also to be appreciated that the base member 13 does not need to form a perfect triangle, but may also be formed as a portion of a curve rather than two straight sections as seen in FIG. 4 extending to form the apex, and could potentially be contiguously and integrally formed with the side members as well.

It is important that the left side member 9, right side member 11, base member 13 as well as at least the support member 29 are fabricated from hollow stock material, for example hollow steel stock, so that essentially off-the-shelf, inexpensive materials can be used to fabricate the main portions of the U-shaped frame 3. In this way only the end plates of the frame which form for example corner gussets 28 and rear pivot braces 37 discussed in further detail below, need to be cut, welded and formed by additional labor. This is a tremendous cost savings whenever inexpensive hollow bar stock can be used in fabrication. Many of the known dozer blade support arms are almost entirely formed from custom cut plate so that the entire hitch and blade support is expensive and time consuming to manufacture.

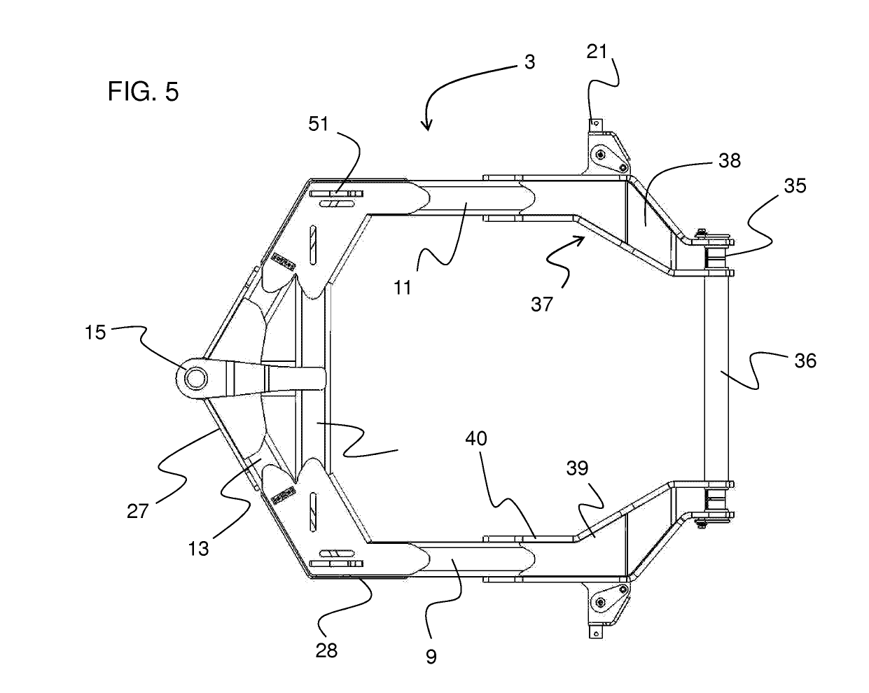

In the embodiment shown in FIG. 4, a corner gusset 28, or gussets are also provided at the intersection of the base member 13, the respective left and right side member 9, 11 and the reinforcement support member 29 to further strengthen this part of the U-shaped frame 3. The front vertical hydraulic attachment point 33 is provided in conjunction with the corner gusset(s) 28 to facilitate raising and lowering of the U-shaped frame 3. The U-shaped frame 3 also includes a rear pivot hinge 35 about which the entire U-shaped frame 3 rotates to provide upward and downward adjustment of the U-shaped frame 3 and blade, i.e. vertical movement of the blade implement. Each of the rear pivot hinges 35 are supported by a rear pivot brace 37. The rear pivot brace 37 has an angled first end 38 supporting one end of the rear pivot hinge 35, a central support portion 39 and a lateral second end 40 that receives a rear end of the side members 9, 11 of the U-shaped frame 3. A rear pivot hinge support 36 is connected between each of the rear pivot hinges 35. FIG. 5 is a top view of the U-shaped frame 3 showing the central pivot gusset 27, the side gusset(s) 28 and rear pivot brace(s) 37 enclosing the base member 13 and side members 9, 11 to strengthen and support the structure of the U-shaped frame 3.

As better seen in FIG. 2, the angled end 38 of each rear pivot support 37 is angled upwards from a first plane defined by the side and base members of the U-shaped frame 3 so that a portion of the rear pivot brace 37 is itself aligned along a second plane, or an axis spaced from that defined by the side members 9, 11 and base member 13 of the U-shaped frame 3. This relative spacing caused by the angled end portion 38 of each rear pivot brace 37 defines the difference in the planar separation between the rear pivot hinge 35 and the left and right side members 9, 11 and base member 13 and substantially facilitates the articulation and height adjustment of the U-shaped frame 3 and blade implement relative to the body 5 of the vehicle.

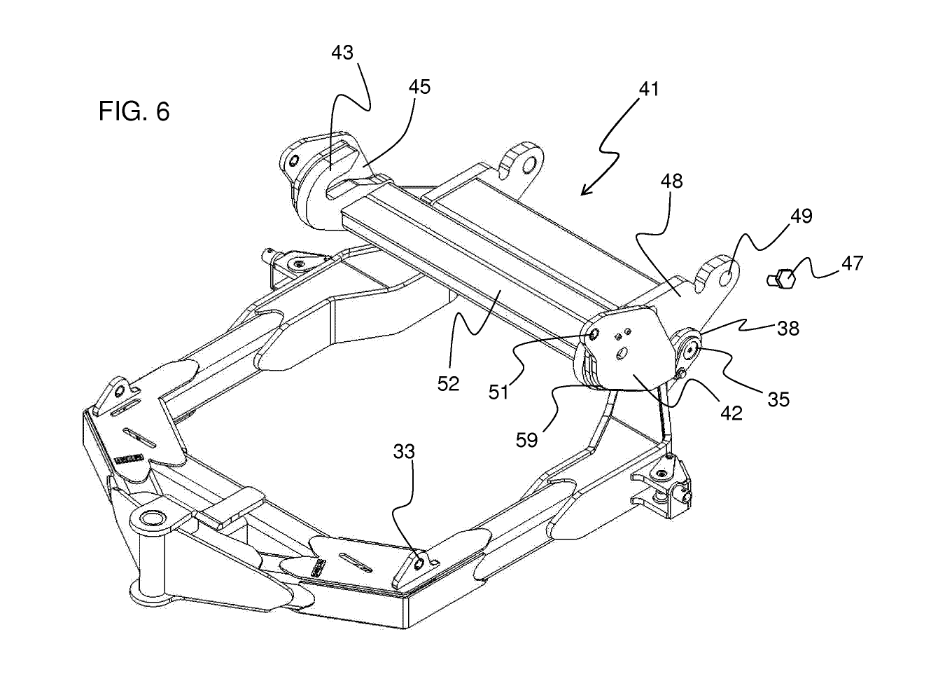

As shown in FIG. 6 the other part of the attachment assembly 1, a frame link 41, directly supports the U-shaped frame 3 to the body 5 of the vehicle. As will be discussed in further detail below, this frame link 41 not only rotatably supports the U-shaped frame 3 and secures it directly to the vehicle body 5, but also includes hydraulic attachment points 51 and an angular or sloped edge 59 forming a stop surface for limiting the vertical articulation of the U-shaped frame 3 about the front of the vehicle 5 or tractor. The terms vehicle 5 and tractor are used interchangeably to describe the general type of vehicle which maneuvers and carries the hitch attachment 1 and blade implement, many types of agricultural and industrial vehicles may certainly be contemplated by the present invention.

The U-shaped frame member 3, in particular the rear pivot hinge 35 is directly supported by the frame link 41 shown in FIG. 3 which is directly and immovably fixed to the frame or body 5 of the vehicle. For purposes of discussion we refer to the frame and body of the carrying vehicle, as the vehicle “body” to differentiate it from the other uses of the term “frame” herein. The frame link 41, not shown attached to the vehicle body 5 in FIG. 6 for purposes of description, performs two important functions, first and foremost it rotatably supports the U-shaped frame 3 at the rear pivot hinge 35 and allows it to rotate about the rear pivot hinge 35 and raise and lower the blade implement. Secondly, the frame link 41 can be quickly and easily attached and detached to the vehicle body 5 via a hanger arrangement. The frame link 41 includes a pair of mounting plates 48 mated with the rear pivot hinge 35 and inserted in the angled end 38 of the rear pivot brace 37. The bracket 42 and a link support 52 extend between and connect the mounting plates 48. A hanger 43 is formed at one end of each mounting plate 48 and a securing hole 49 is formed at the other end of each mounting plate 48. A pair of laterally extending studs 44 (not shown) are welded, or otherwise attached to the vehicle body 5 and have a dimension intended to fit snugly and be received within a channel 45 defined in the hanger portion 43 of the mounting plate 48 of the frame link 41.

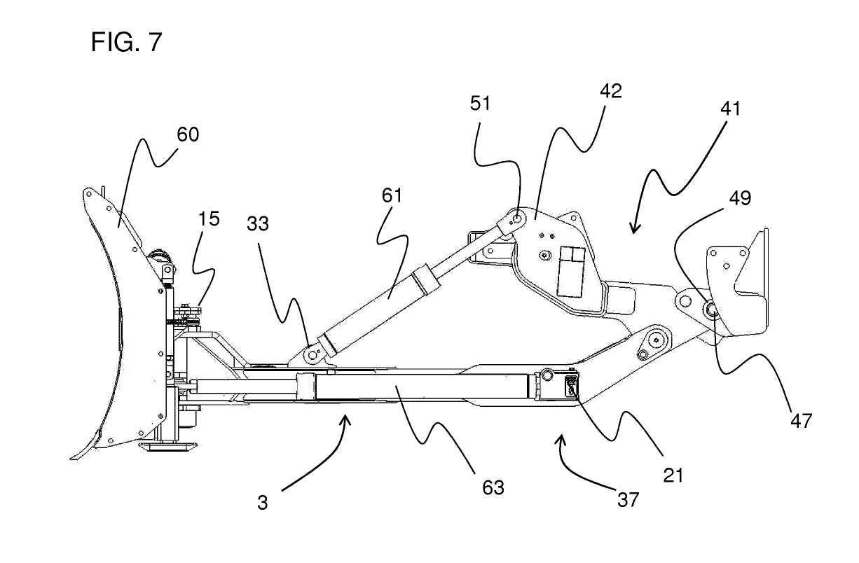

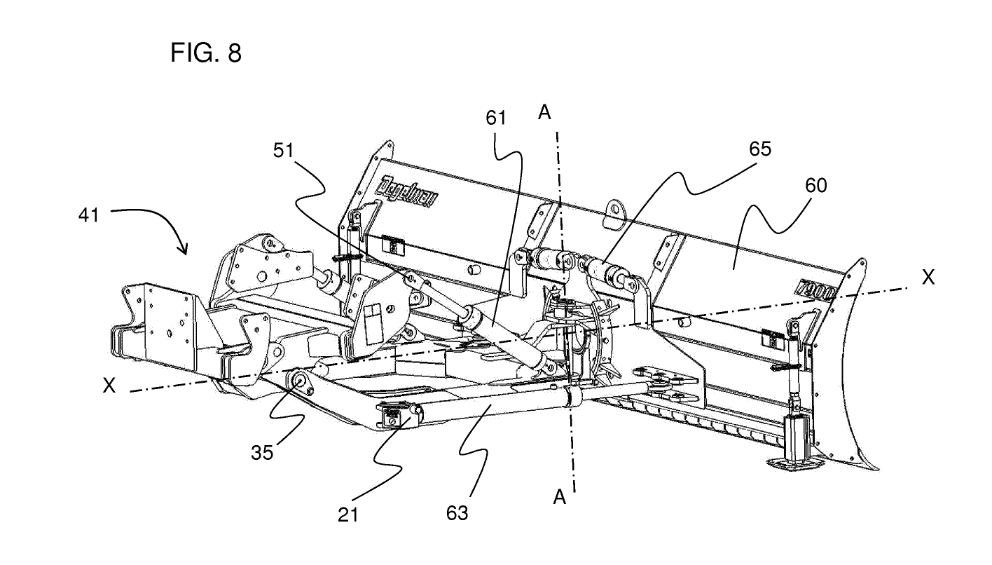

As shown in FIGS. 7 and 8, where the blade implement and hitch attachment are set on the ground and not engaged with a vehicle, the hanger 43 is maintained at a height which matches the height of the extending studs on the vehicle body. In order to initially secure the hitch attachment 1 and/or the blade to a vehicle 5, the operator of the vehicle 5 merely needs to center the vehicle over the attachment 1 and drive forward bringing the studs 44 which are affixed to vehicle body 5 into contact and engage them within the U-shaped hangers 43 on the frame link 41. Then, the operator need only set a securing bolt 47, or a quick release mechanism discussed in detail below, through the respective securing holes 49 to engage the U-shaped frame 3 with a portion of the vehicle frame, or a specific mount provided on the vehicle frame, in order to provide full and complete support for the attachment 1 and implement. It is to be appreciated that the studs 44 may be permanently fixed, welded or otherwise affixed to the body of the vehicle and are small enough so that they do not interfere with any other implements or use of the vehicle except to easily connect and disconnect the frame link 41 and hitch attachment 1 as described above.

As can be seen in FIG. 6, the frame link 41 also includes a vertical hydraulic support attachment point 51 on the frame link bracket 42. This hydraulic support attachment point is for the rear end of the vertical hydraulic pistons which, at the front end of the piston, are attached to the front vertical hydraulic attachment points 33 on the U-shaped frame 3 to motivate the U-shaped frame member up and down about the rear pivot hinge 35. In FIG. 7 the vertical hydraulic piston 61 can easily be observed as it extends between the relative attachment points on the frame link bracket 42 and the U-shaped frame 33. Also here can be seen arranged substantially parallel with the U-shaped frame is the lateral hydraulic piston 63 for controlling the lateral movement of the blade implement 60 about the central pivot 15. The lateral hydraulics would generally connect from the lateral hydraulic attachment point 21 on the rear pivot brace 37 directly to the backside of the blade implement 60 for controlling a lateral rotation of the blade implement about the central pivot point 15. A further description of the associated hydraulics is provided below with respect to FIGS. 8, 9 and 10.

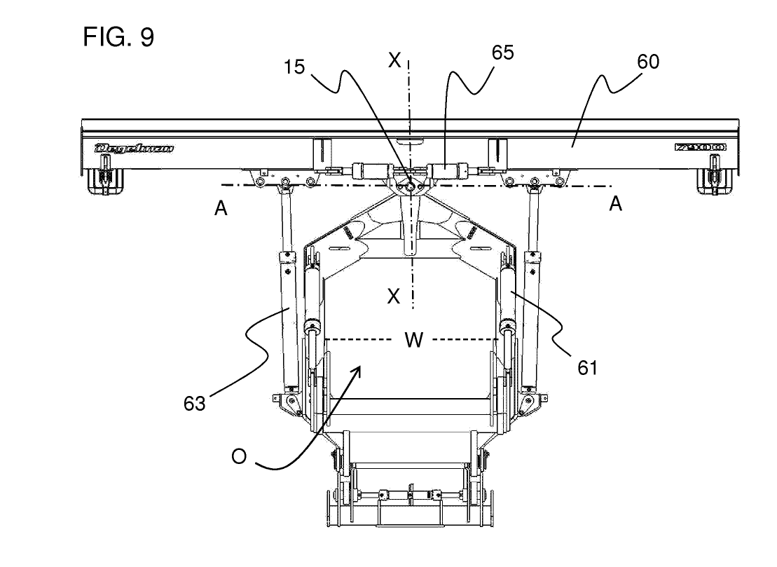

Turning to FIGS. 8 and 9, a perspective and top plane view of the vertical and lateral hydraulic pistons discussed above is shown. Also seen here is the left and right tilt hydraulics 65 which enables the blade implement 60 to rotate about a central longitudinal axis X perpendicularly intersecting the central pivot axis A. In this way the operator may not only raise and lower the blade implement 60, and rotate the blade laterally about the substantially vertical pivot axis, but it may also be tilted to the left and right about the central longitudinal axis X to change the relative heights of the left and right side of the blade implement relative to the ground surface, for instance to dig a ditch along the side of a road. For further frame of reference, the central longitudinal axis X is generally drawn along i.e. parallel with, the direction of travel of the vehicle 5 and blade implement 60. In this way the blade implement 60 is connected to the U-shaped frame 3 along two axes of rotation, the central pivot A and a central longitudinal pivot X and where the rotation of the U-shaped frame 3 about the rear pivot hinge 35 provides a relative height adjustment of the entire blade 60 relative to the vehicle 5 and the ground.

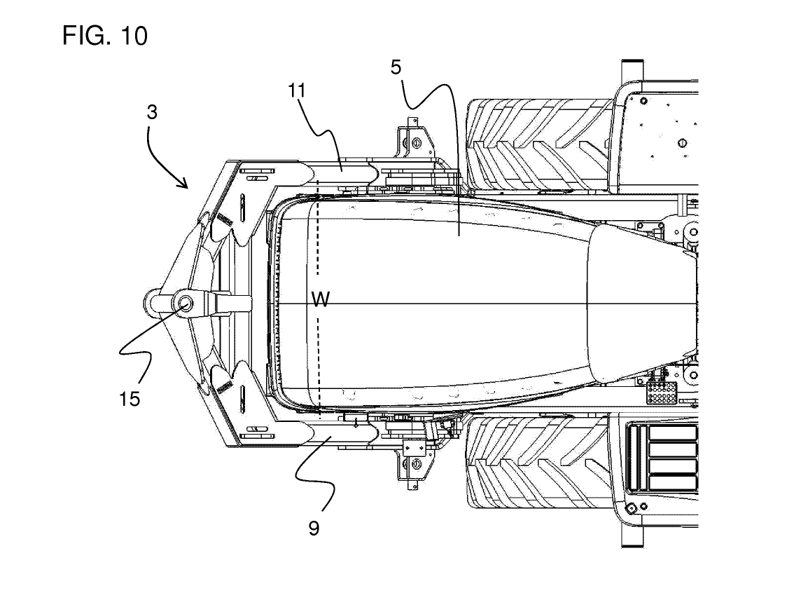

FIG. 9 shows the width W of the opening O defined by the U-shaped frame 3. The width W is wider than the front of the tractor as clearly seen in FIG. 10 so that the U-shaped frame is free to be raised to any level and encompass the tractor body between the left and right side members 9, 11 without interference. Generally it is the vertical hydraulic piston 61 which will define the height to which the U-shaped frame can be raised around the front body portion of the tractor or vehicle and which ensures that the frame is not raised so high as to have the base member 13 or reinforcement member 29 contact the front of the tractor body. The hydraulic pistons 61 are also outside the width of the tractor as shown in FIG. 9 to ensure that the pistons 61 are not inhibited by the tractor body as well.

In this way, the frame 3 can be permitted to be raised and lowered through the angle P as best seen in FIG. 2 where the vertical rise of the hitch is met by a sloped edge 59 of the frame link 41 which limits the raising height of the U-shaped frame 3 before the base of the U-shaped frame can abut the front of the vehicle.

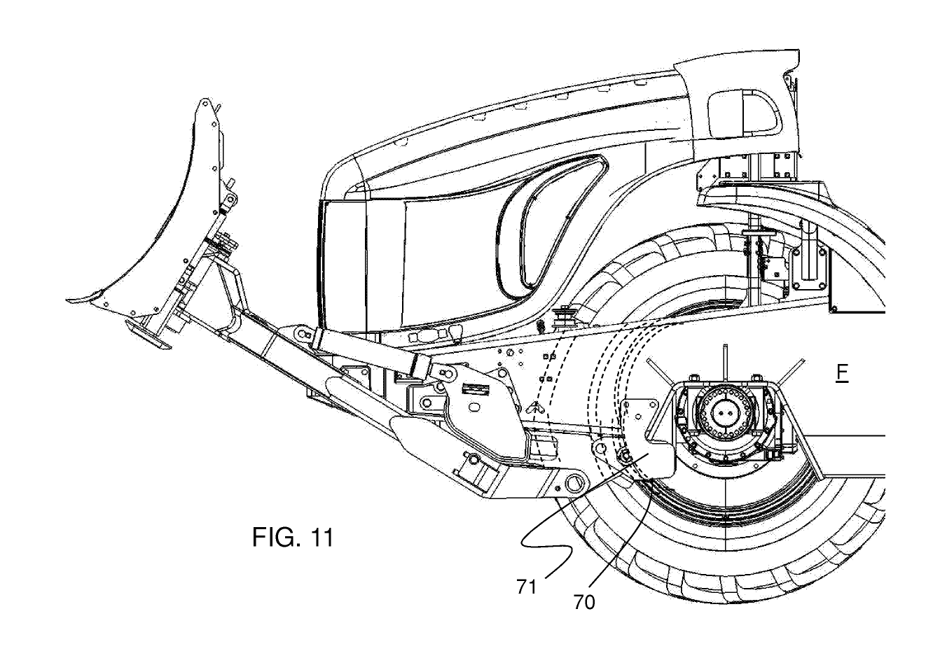

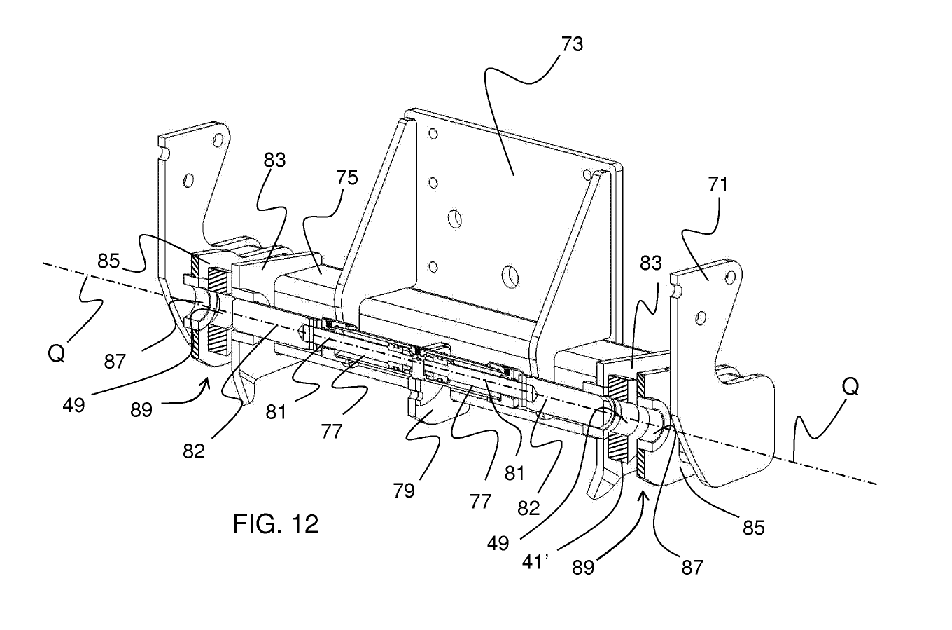

The U-shaped frame 3 and frame link 41 as seen best in FIG. 6 may be best attached to the vehicle by a quick release mechanism which includes a frame mount 70 shown in FIGS. 11-15. The frame mount 70 is directly attached to the frame F of the vehicle by outer support bar plates 71 and an axle bracket 73 including a support bar 75 extending between the outer support bar plates 71 best seen in FIG. 12. A pair of linearly and opposingly arranged hydraulic pin actuators 77 are supported by a carrier bracket 79 on the support bar 75 and extend parallel with the support bar 75. The piston 81 of each of the hydraulic pin actuators 77 has at each end a pin 82 for securely engaging and attaching the U-shaped frame 3 and frame link 41 to the frame mount 70 and hence the vehicle.

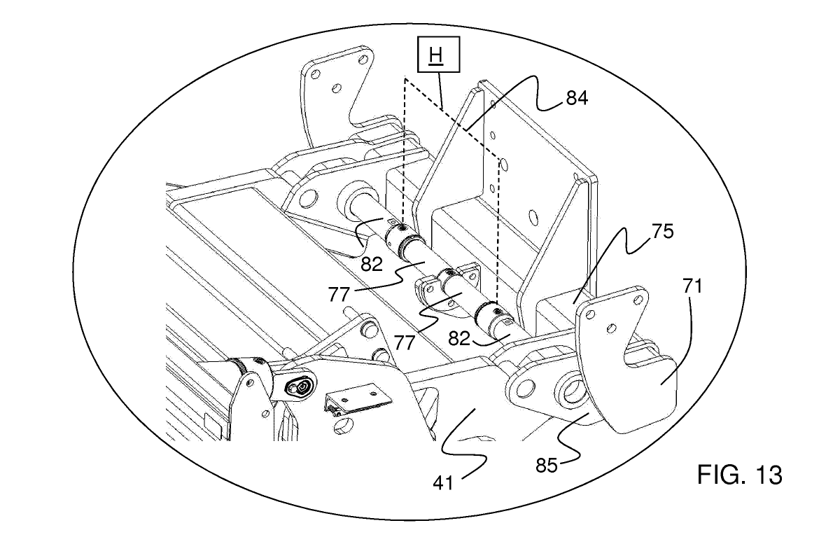

In the embodiment shown in FIGS. 12 and 13, which is the unsecured and retracted position of the frame and mount, each pin 82 is supported at one end by the attachment to the piston 81 and at a second end by a passage through an inner support bar plate 83. An intermediate support bar plate 85 having a pin receiving passage 87 is axially spaced from the inner support bar plate 83 to define a receiving space 89 into which an end portion 41′ of the frame link 41 having the securing holes 49 is received. What is shown here for purposes of clarity is merely the end portion 41′ of the frame link 41 and part of the securing hole 49. It is to be appreciated that it is the frame link 41 of course which directly supports the U-shaped frame 3 is now shown in this figure.

As can be appreciated from the above disclosure and described structure along with FIG. 13, a tractor or vehicle 5 with the frame mount 70 attached underneath can be driven by the operator H, essentially over frame link 41 and into the U-shaped frame 3, to engage the hanger 43 and permitting the end of the frame link 41 to enter the receiving space 89. As will be explained in detail below, once this is accomplished the operator H need simply actuate the hydraulic pin actuators 77 from the cab of the tractor via the connected hydraulic system and hoses 84 and the pistons 81 and pins 82 extend through the securing holes 49 to secure the U-shaped frame 3 to the frame mount 70 and hence the tractor or vehicle 5.

The hydraulic pin actuators 77 along with the pin receiving passage 87 define a quick release axis Q. It is important to recognize that the quick release axis Q is parallel to but arranged lower relative to the ground than the front wheel axle as best seen in FIG. 11. This arrangement facilitates maintaining the forces which are applied through the hitch from the blade directly to the frame F at a plane which is lower than the vehicle axle. Where the forces from the blade are applied along a relatively straight angle of attack from the blade through the U-shaped frame 3 to the vehicle, and impacting the vehicle frame at a point below or even planarly aligned with the front axle of the tractor, this arrangement facilitates the stability and handling of the tractor. Any vehicle has generally better stability and handling when the center of gravity including any forces applied to the vehicle which can effect the center of gravity are maintained lower to the ground. This is particularly more difficult to achieve with tractors and other wheeled vehicles where the main road wheel axles may be located quite high for ground clearance purposes. This quick release hitch attachment facilitates maintaining these forces and centers of gravity of the vehicle as low to the ground as possible.

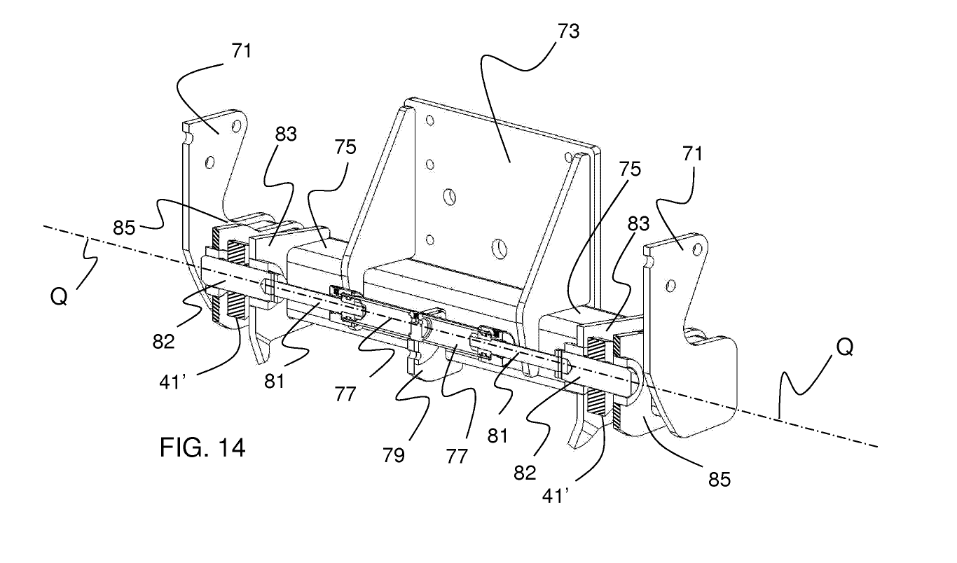

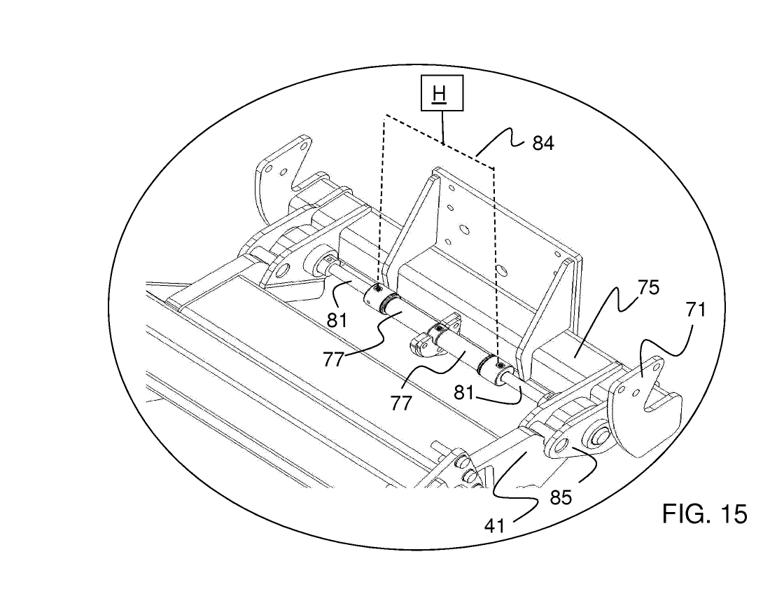

The embodiment shown in FIGS. 14 and 15 is the secured and extended position of the frame and mount, each pin 82 has now been extended by the respective hydraulic cylinders 77 and piston 81 through the inner support bar plate 83, across the receiving space 89, and into the pin receiving passage 87 of the intermediate support bar plate 85. As the pin 82 crosses the receiving space 89 it passes through the securing holes 49 in the link end portion 41′ to connect the U-shaped frame 3 securely to the tractor or vehicle 5. FIG. 15 shows the extension in complete detail with pistons 81 extended securing the U-shaped frame 3 to the tractor 5.

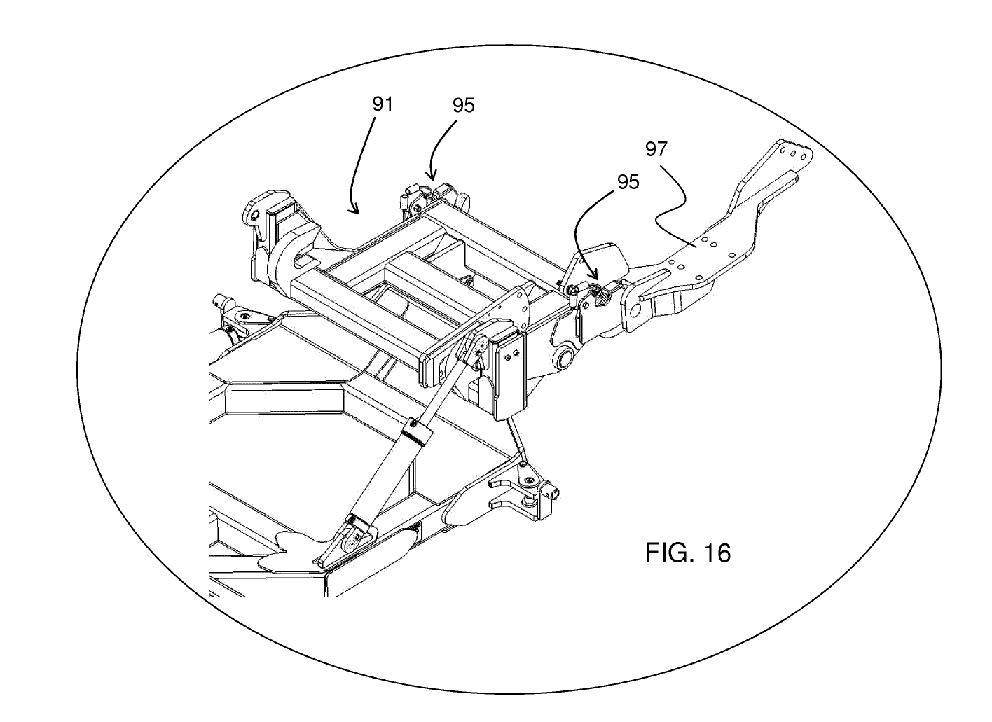

In another embodiment of the quick release mechanism shown in FIGS. 16-18, a frame link 91 is provided with a spring loaded wedge bar 93 which extends and retracts to secure the frame and blade to the tractor. The frame link 91 includes a receiver 95 for engaging a transverse bar or pin 96 mounted underneath the vehicle or tractor on a frame mount 97 for example. As will be explained in further detail below, when the receiver 95 is engaged with the bar or pin 96 an operator actuates the spring loaded wedge bar 93 to secure the bar or pin 96 in the receiver 95 so that there is as little play, i.e. space, gap and movement, as possible between the receiver 95 and the bar or stud 96. Experience has shown that any play between the mounting hardware and pin leads to faster product and mounting hardware deterioration. The spring loaded wedge bar 93 ensures constant contact and continuous pressure between the receiver 95 and bar or pin 96 so that such play is eliminated even with wear of the mounting hardware over time.

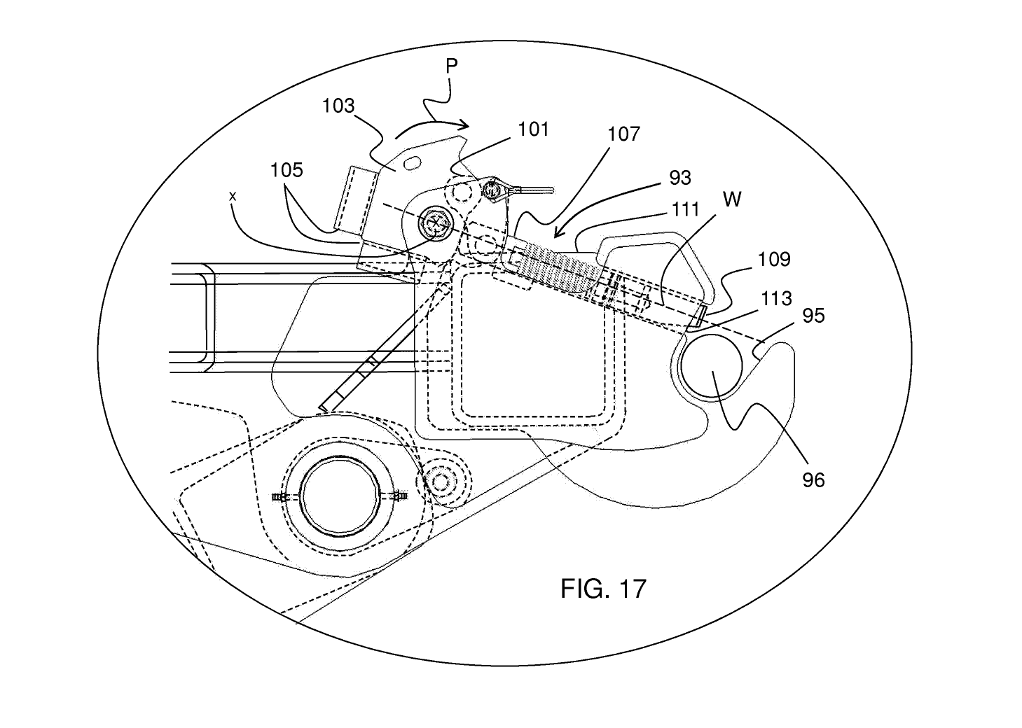

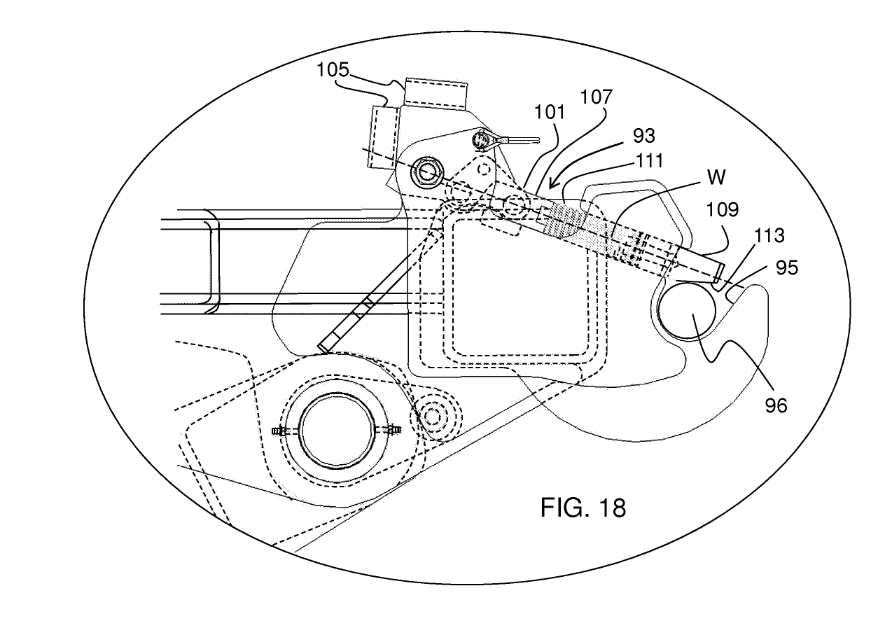

As seen in FIG. 17, the wedge bar is connected via a link 101 to an actuator 103. The actuator 103 rotates about an actuator axis X when manually or mechanically motivated. An operator may manually rotate the actuator 103 by inserting a handle or pipe (not shown) into either of the available sockets 105 integral with the actuator 103 to gain leverage. As can be appreciated by observing the difference between FIGS. 17 and 18, when an operator rotates the actuator 103 via the handle in the direction P, the actuator 103 motivates the link 101 to push the wedge bar 93 across the opening of the receiver and into engagement with the pin 96.

In the retracted position as seen in FIG. 17, the wedge bar 93 allows entry of the bar or pin 96 into the receiver 95. The wedge bar 93 has a butt portion 107 and a tip portion 109 connected by a spring 111 which permits the tip portion a certain amount of bias and axial travel, i.e. compression, relative to the butt portion 107 The tip portion 109 includes a ramp 113 which is intended to contact in a tangential manner the bar or pin 96 as the wedge bar 93 is pushed across the opening into the receiver 95. It is to be appreciated that as the ramp 113 contacts the pin 96 an axial force pushes the tip portion 109 against the bias of the spring 111 so that firm spring biased contact is ensured between the wedge bar 93 and the pin 96. Because of the sloped nature of the ramp 113 the tip portion 109 is able to directly contact pins 96 of different diameters which may for example occur due to wear over time.

As seen in FIG. 18 because the axis of rotation of the actuator is axially aligned along the main axis W of the wedge bar 93, with the mechanism now rotated into the engaged and extended position, the arrangement of the link 101 essentially locks the wedge bar 93 into an extended position and axial force along the axis W further locks the mechanism and wedge bar 93 against the pin 96 and at least partially across the opening of the receiver ensuring a firm, stable contact between the mounting hardware so that the hitch and blade is securely carried by the tractor.

The invention has been described in detail with particular reference to certain preferred embodiments thereof, but it will be understood that variations and modifications can be effected within the spirit and scope of the invention.

I/we claim:

1. A materials moving implement attachment apparatus for a vehicle comprising:
a U-shaped frame having a first side member and a second side member connected at respective first ends by a base member extending therebetween;
a blade support is provided on the base member for attachment of a materials moving blade;
a rear pivot hinge connected between a respective second end of each of the first and second side member; and
wherein the first and second side members define an opening therebetween having a larger dimension than a front body section of the vehicle permitting the U-shaped frame to be rotated about the rear pivot hinge and allowing at least a portion of the front body section of the vehicle to pass into the space between the first and second side members.

2. The materials moving implement attachment apparatus for a vehicle as set forth in claim 1 further comprising a frame link for rotatably supporting the U-shaped frame at the rear pivot hinge and wherein the frame link is supported on opposing sides of the front body section of the vehicle.

3. The materials moving implement attachment apparatus for a vehicle as set forth in claim 2 wherein the frame link comprises a first and second substantially horizontally aligned receiving slots spaced wider than the width of the front body section of the vehicle for receiving spaced apart respective mating points affixed to opposing sides of the front body section of the vehicle.

4. The materials moving implement attachment apparatus for a vehicle as set forth in claim 3 wherein the frame link further comprises a first and second frame attachment member spaced wider than the width of the front body section of the vehicle, each having a single attachment aperture for receiving a securing member to secure the frame link to opposing sides of the front body section of the vehicle.

5. The materials moving implement attachment apparatus for a vehicle as set forth in claim 2 further comprising a hydraulic piston attached between the U-shaped frame and the frame link to rotate the U-shaped frame member about the rear pivot hinge and raise the U-shaped frame member to a height so that at least a portion of the front body section of the vehicle passes entirely through the opening between the first and second side member.

6. The materials moving implement attachment apparatus for a vehicle as set forth in claim 5 wherein the frame link comprises a stop surface defining an upper limit to the vertical articulation of the U-shaped frame member.

7. The materials moving implement attachment apparatus for a vehicle as set forth in claim 6 wherein the U-shaped frame further comprises a hydraulic piston attachment point positioned along the first and second side members for supporting a hydraulic piston for controlling lateral movement of the materials moving implement.

8. The materials moving implement attachment apparatus for a vehicle as set forth in claim 1 further comprising a base support member extending between the first and second side members and with the base member defining a substantially triangular shaped portion of the U-shaped frame for reinforcing the blade support on the U-shaped frame.

9. The materials moving implement attachment apparatus for a vehicle as set forth in claim 8 where the substantially triangular shaped portion of the U-shaped frame is co-planar with the plane defined by the side members and the base member.

10. A materials moving implement hitch for a vehicle comprising:
a U-shaped frame having a pair of generally parallel side members, each side member having a vertical actuator attachment and a horizontal actuator attachment, a base member connecting forward ends of the side members, a blade support affixed to the base member for attachment of a materials moving blade, a rear pivot brace affixed to the rearward end of each side member;
a frame link for vertically, pivotally affixing the U-shaped frame to a vehicle, the frame link having a pair of oppositely disposed mounting plates, each mounting plate adapted to secure to a vehicle and rotatably engage with one of the pivot braces of the U-shaped frame; and
wherein the pair of generally parallel side members are spaced apart a distance exceeding a width of a front body portion of the vehicle and the U-shaped frame is movable between a first position substantially parallel aligned with a ground surface below the front body portion of the vehicle and a second position wherein U-shaped frame at least partially encompasses the front body portion of the vehicle between the generally parallel side members.

11. The materials moving implement hitch as set forth in claim 10 wherein each rear pivot brace comprises a forward end collinear with the side member and a rearward end offset relative to the forward end inward between the parallel side members.

12. The materials moving implement hitch as set forth in claim 11, wherein each mounting plate comprises a receiver passage for receiving one of a securing bolt and stud for securing the mounting plate to the vehicle.

13. The materials moving implement attachment apparatus for a vehicle as set forth in claim 12, wherein the receiver passage for attaching the respective mounting plates of the frame link to opposite sides of the vehicle comprises a hanger having generally horizontal channel on the frame link bracket.

14. The materials moving implement hitch as set forth in claim 10 further comprising a set of cooperating vertical actuators each connected at respective upper ends to the frame link and at respective lower ends to the corresponding side members to articulate the U-shaped frame between the first and second positions.

15. The materials moving implement hitch as set forth in claim 14 further comprising a set of cooperating horizontal actuators connected at respective rearward ends to the side member horizontal actuator attachments and at respective forward ends to a materials moving implement supported by the blade support.

16. The materials moving implement hitch as set forth in claim 11 wherein the U-shaped frame further comprises a rear pivot hinge arranged at the rearward offset end of each of the rear pivot brace to engage with the frame link.

17. The materials moving implement hitch as set forth in claim 10 wherein the first and second position of the U-shaped frame define an angle through which the U-shaped frame rotates and the angle includes at least a part of the front body portion of the vehicle within the angle.

18. A method for manufacturing a materials moving implement attachment apparatus for a vehicle comprising:
forming a U-shaped frame having a first side member and a second side member connected at respective first ends by a base member extending therebetween;
providing a blade support on the base member for attachment of a materials moving blade;
connecting a rear pivot hinge between a respective second end of each of the first and second side members; and
defining an opening between the first and second side members having a larger dimension than a front body section of the vehicle permitting the U-shaped frame to be rotated about the rear pivot hinge and allowing at least a portion of the front body section of the vehicle to pass entirely through the space between the first and second side members.

19. The method for manufacturing a materials moving implement attachment apparatus as set forth in claim 18 further comprising the step of providing a frame link for rotatably supporting the U-shaped frame at the rear pivot hinge and supporting the frame link on opposing sides of the front body section of the vehicle.

20. The method for manufacturing a materials moving implement attachment apparatus for a vehicle as set forth in claim 18 further comprising the step of forming at least the first and second side members and the base member from hollow bar stock material.
